(19) United States
(12) Patent Application Publication
(10) Pub. No.: US 2025/0174801 A1
(43) Pub. Date: May 29, 2025

(54) ON-BOARD STRUCTURE FOR BATTERY PACKS

(71) Applicant: HONDA MOTOR CO., LTD., Tokyo (JP)

(72) Inventors: Daigo KOMATSU, Tokyo (JP); Keiji TAKEUCHI, Tokyo (JP)

(73) Assignee: HONDA MOTOR CO., LTD., Tokyo (JP)

(21) Appl. No.: 18/951,710

(22) Filed: Nov. 19, 2024

(30) Foreign Application Priority Data
Nov. 24, 2023 (JP) 2023-199084

(51) Int. Cl. H01M 50/249; H01M 50/242; H01M 50/264; H01M 50/271; H01M 50/296

(52) U.S. Cl. CPC H01M 50/249; H01M 50/242; H01M 50/264; H01M 50/271; H01M 50/296

(57) ABSTRACT

An on-board structure for battery packs, includes a first battery pack and a second battery pack which are arranged adjacent each other in a front-rear direction of a vehicle, a central frame which is disposed between the first battery pack and the second battery pack and extends in a vehicle width direction, and a side frame which is disposed on at least one side in the vehicle width direction of the first battery pack and the second battery pack and extends in the front-rear direction. The central frame has a hollow shape. The central frame accommodates therein a conductive member that electrically connects the first battery pack and the second battery pack. The first battery pack and the second battery pack are fixed to the central frame and the side frame. The central frame and the side frame are fixed to the vehicle.

### CROSS-REFERENCE TO RELATED APPLICATIONS

This application is based on and claims priority under 35 USC 119 from Japanese Patent Application No. 2023-199084 filed on Nov. 24, 2023, the entire content of which is incorporated herein by reference.

### TECHNICAL FIELD

The present disclosure relates to an on-board structure for battery packs.

### BACKGROUND ART

In recent years, researches and developments have been conducted on a secondary battery which contributes to improvement in energy efficiency in order to allow more people to have access to affordable, reliable, sustainable and advanced energy.

An electric vehicle or a hybrid vehicle in the related art is generally mounted with a single battery pack obtained by accommodating a plurality of battery modules in a battery case. For example, JP2023-504158A proposes a battery pack including a plurality of modules, a waveguide disposed between modules facing each other, and a battery case accommodating them.

However, this case requires to design a battery pack for each vehicle, and thus has no versatility of battery packs.

Further, in the battery pack disclosed in JP2023-504158A, the waveguide is provided on the bottom surface in a manner traversing the center region of the pack case. The waveguide is fixed to the inner wall and thus can prevent deformation of the pack due to external impact, but does not contribute to the fixing to the vehicle. Therefore, a separate structure for fixing the battery pack to the vehicle is required.

### SUMMARY OF INVENTION

The present disclosure provides an on-board structure for battery packs, which enables to mount a plurality of highly versatile battery packs on a vehicle, while reducing the number of components and saving space. This further contributes to improvement in energy efficiency.

An aspect of the present disclosure relates to an on-board structure for battery packs, including:
a first battery pack and a second battery pack each accommodating a cell laminate having a plurality of laminated battery cells, the first battery pack and the second battery pack being arranged adjacent each other in a front-rear direction of a vehicle;
a central frame disposed between the first battery pack and the second battery pack and extending in a vehicle width direction; and
a side frame disposed on at least one side in the vehicle width direction of the first battery pack and the second battery pack and extending in the front-rear direction,
in which the central frame has a hollow shape,
the central frame accommodates therein a conductive member that electrically connects the first battery pack and the second battery pack,
the first battery pack and the second battery pack are fixed to the central frame and the side frame, and
the central frame and the side frame are fixed to the vehicle.

According to the aspect of the present disclosure, it is possible to mount a plurality of highly versatile battery packs on a vehicle, while reducing the number of components and saving space.

### BRIEF DESCRIPTION OF DRAWINGS

Exemplary embodiment(s) of the present invention will be described in detail based on the following figures, wherein:

FIG. 1 is an external perspective view of a battery pack 10;

FIG. 2 is an exploded perspective view of the battery pack 10;

FIG. 3 is an exploded perspective view of a cell laminate 30;

FIG. 4 is a plan view of the battery pack 10;

FIG. 5 is an external perspective view of a battery assembly 100;

FIG. 6 is a cross-sectional view taken along a line A-A of FIG. 5;

FIG. 7 is an external perspective view of the battery assembly 100 when viewed from the bottom surface, with a bottom cover 126 being disassembled;

FIG. 8 is an external perspective view of a central frame 120; and

FIG. 9 is an external perspective view of the central frame 120 when viewed from the bottom surface, with the bottom cover 126 being disassembled.

### DESCRIPTION OF EMBODIMENTS

Hereinafter, an embodiment of a battery pack of the present disclosure will be described with reference to the accompanying drawings. In the following description, for convenience, a coordinate system including a front-rear direction, a left-right direction, and an upper-lower direction orthogonal to each other is used. In the drawings, the front side is denoted by Fr, the rear side is denoted by Rr, the left side is denoted by L, the right side is denoted by R, the upper side is denoted by U, and the lower side is denoted by D. However, these directions are not related to a direction when the battery pack is mounted on a device. For example, when the battery pack is mounted on a vehicle, an upper-lower direction of the battery pack may be oriented in a traveling direction of the vehicle or in a vehicle width direction when the battery pack is mounted on the vehicle.

### Battery Pack

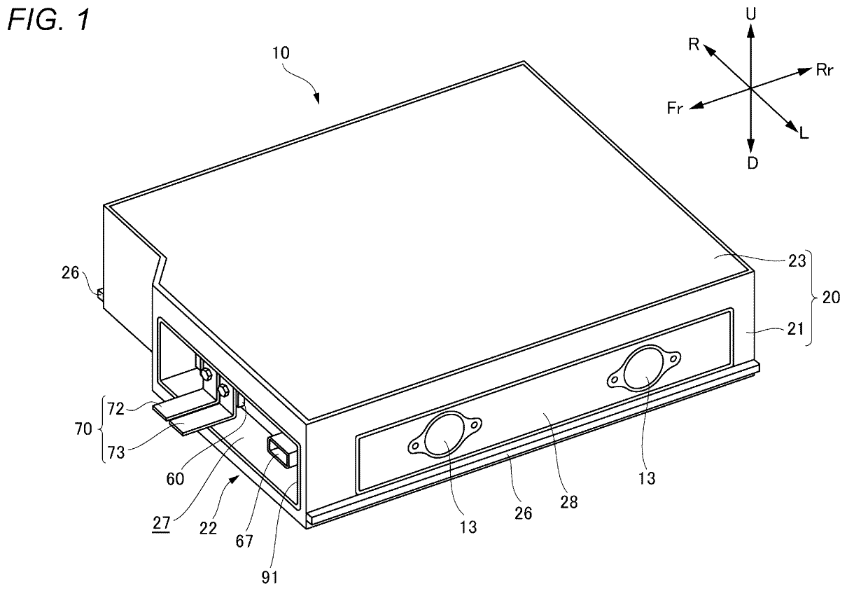

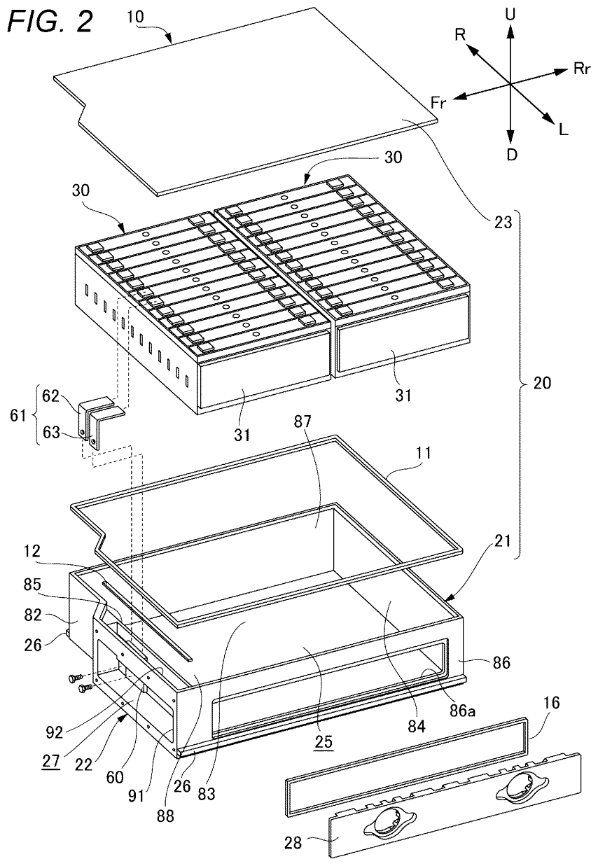

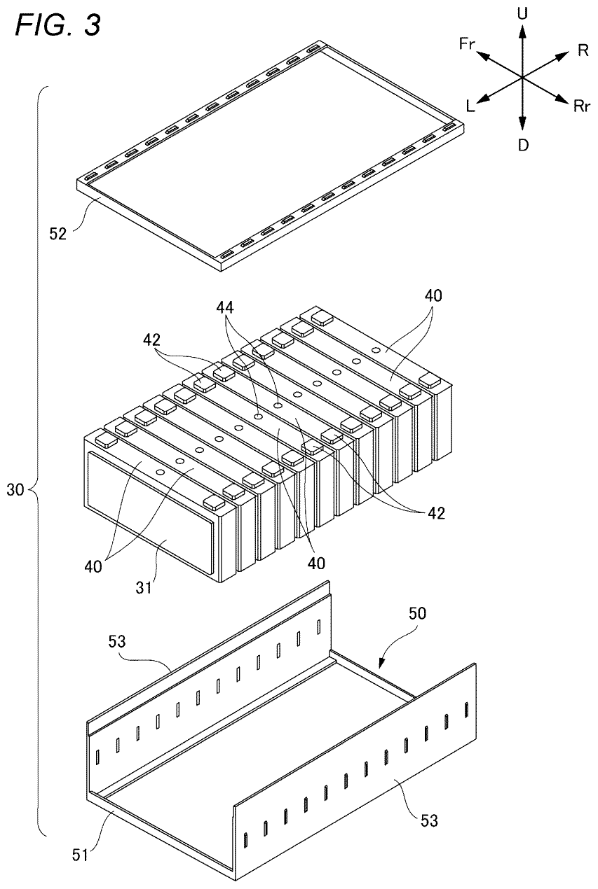

In the battery pack 10, as illustrated in FIGS. 1 and 2, two cell laminates 30 are aligned in the front-rear direction inside a box-shaped case 20. As illustrated in FIG. 3, each cell laminate 30 includes a plurality of square battery cells 40 laminated in the left-right direction, and an end plate 31 disposed on one side in the left-right direction (the left side in the present embodiment), which are temporarily fixed at a predetermined pressure by using a binder 50. A separator (not illustrated) may be disposed between adjacent battery cells 40. The binder 50 includes a rectangular lower restraint portion 51 surrounding the bottom surface of the cell laminate 30, a rectangular upper restraint portion 52 surrounding the upper surface of the cell laminate 30, and a pair of side restraint portions 53 sandwiching the cell laminate 30 in the front-rear direction. The lower restraint portion 51 and the pair of side restraint portions 53 are formed integrally. The other side in the left-right direction (the right side in the present embodiment) of the cell laminate 30 may be provided with another end plate, a separator, or the like, so that the battery cells 40 are not in direct contact with the case 20 on the other side. The cell laminate 30 may not be configured such that the plurality of battery cells 40 are restrained by the binder 50. That is, the plurality of battery cells 40 may be directly laminated inside the case 20.

The battery cells 40 are each, for example, a secondary battery such as a lithium ion battery. The upper surface of the battery cell 40 is provided with a pair of terminals 42 and a safety valve 44 disposed between the pair of terminals 42. The pair of terminals 42 include a positive terminal and a negative terminal. For example, the positive terminal is connected to the negative terminal of an adjacent battery cell 40 via a bus bar (not illustrated), and the negative terminal is connected to the positive terminal of an adjacent battery cell 40 via a bus bar (not illustrated), whereby the plurality of battery cells 40 are electrically connected in series. For example, in order to shorten the length of the bus bar, the plurality of battery cells 40 may be laminated such that the orientations thereof in the front-rear direction are reversed alternately.

The safety valve 44 is a rupture valve, and prevents rupture of the outer can when the internal pressure of the battery cell 40 abnormally rises. If the internal pressure of the battery cell 40 abnormally rises, the safety valve 44 ruptures and the gas in the battery cell 40 is discharged to the outside. By providing the safety valve 44 in the central portion of the battery cell 40 in the front-rear direction, the plurality of battery cells 40 can be aggregated at the same position in the front-rear direction even if laminated such that the orientations thereof in the front-rear direction are reversed alternately.

Returning to FIG. 2, the case 20 includes a case body 21 whose upper side is open, and a case cover 23 that covers the opening of the case body 21. The case body 21 includes a front wall 82 and a rear wall 84 that extend in the left-right direction, a left wall 86 that connects the left ends of the front wall 82 and the rear wall 84, a right wall 87 that connects the right ends of the front wall 82 and the rear wall 84, and a bottom wall 88. A space surrounded by the front wall 82, the rear wall 84, the left wall 86, and the right wall 87 constitutes a cell accommodation space 25 for accommodating the cell laminates 30.

The left wall 86 is provided with an opening 86a that allows the cell accommodation space 25 to communicate with the outside, and is attached with a pressurization plate 28 via a seal member 16 (for example, a rubber seal). By fixing the pressurization plate 28 to the left wall 86, the pressurization plate 28 comes into contact with the end plate 31 of each cell laminate 30 from the opening 86a. When the pressurization plate 28 presses the end plate 31 inward, the cell laminate 30 temporarily fixed to the binder 50 at a predetermined pressure is further pressurized in the lamination direction and held in the case 20. The pressurization plate 28 may be fixed to the left wall 86 by welding such as friction stir welding, or may be fixed by bolts.

As illustrated in FIG. 1, the pressurization plate 28 is provided with two pressure relief valves 13 communicating with the cell accommodation space 25. When the internal pressure of the cell accommodation space 25 abnormally rises due to the gas generated from the safety valve 44 of the battery cell 40, the pressure relief valves 13 are opened to discharge the gas in the case 20 to the outside.

The outer surfaces of the left wall 86 and the right wall 87 are provided with protrusions 26 extending in the front-rear direction and protruding in a direction away from the battery pack 10 below the intermediate portion of the battery pack 10 in the height direction, for example, near the bottom surface. The bottom surfaces of the protrusions 26 are one step higher than the bottom surface of the battery pack 10. In the present embodiment, the bottom surfaces of the protrusions 26 are one step higher than the bottom surface of the battery pack 10, but may be at the same height as the bottom surface of the battery pack 10 and constitute a part of the bottom surface of the battery pack 10.

An expanded portion 22 is formed forward of and leftward of the front wall 82 in a manner protruding further forward of the front wall 82. The expanded portion 22 has a space formed inside, and has a first opening 91 provided in the front surface and a second opening 92 provided in the upper surface. The internal space of the expanded portion 22 is provided with a terminal block 60 connected with a lead-out conductive member 70, and forms an output terminal accommodation space 27. Electrically connected in the terminal block 60 are a terminal (output terminal) of an output conductive member 61 extending from the cell accommodation space 25 to the output terminal accommodation space 27, and a terminal of the lead-out conductive member 70 entering the output terminal accommodation space 27 from the first opening 91. The output conductive member 61 includes a positive-side bus bar 62 and a negative-side bus bar 63 respectively extending from the positive-side output terminal and the negative-side output terminal of the two cell laminates 30 electrically connected in series. The lead-out conductive member 70 includes a positive-side bus bar 72 and a negative-side bus bar 73 respectively connected to external positive terminal and negative terminal.

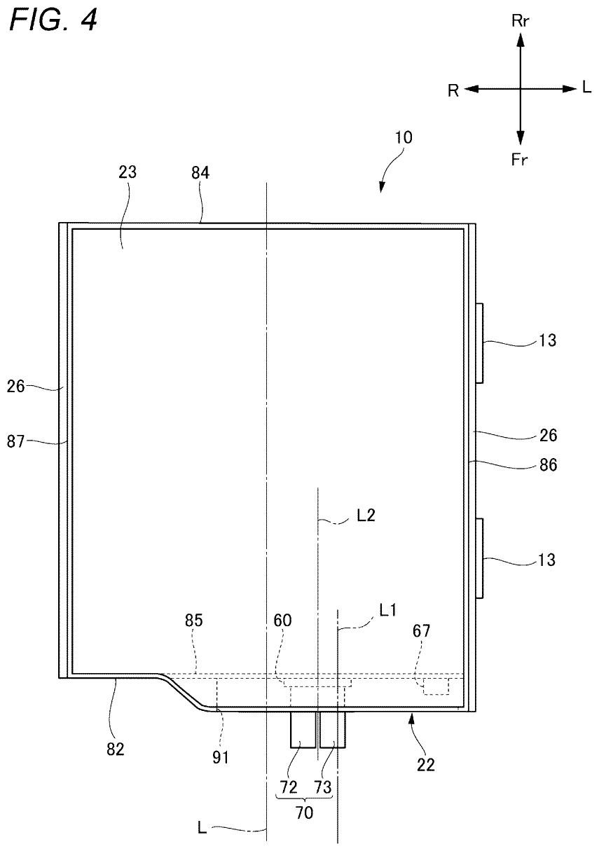

As illustrated in FIG. 4, the first opening 91 is offset in the left-right direction relative to the central line L in the left-right direction of the battery pack 10. That is, the central line L1 of the first opening 91 is offset in the left-right direction relative to the central line L in the left-right direction of the battery pack 10.

The terminal block 60 is also offset in the left-right direction relative to the central line L in the left-right direction of the battery pack 10. That is, the central line L2 of the terminal block 60 is offset in the left-right direction relative to the central line L in the left-right direction of the battery pack 10.

The fastening of the terminal of the output conductive member 61 and the terminal of the lead-out conductive member 70 is preferably bolt fastening. By bolt fastening, the 30 terminals of the output conductive member 61 and the lead-out conductive member 70 may be of a round shape (R shape) or a front-opening type (Y shape). In this way, the battery pack 10 can be mounted on various devices by connecting the lead-out conductive member 70 from the first opening 91 of the output terminal accommodation space 27.

As described above, the case 20 is provided with the cell accommodation space 25 that accommodates the two cell laminates 30, and the output terminal accommodation space 27 arranged forward of and leftward of the cell accommodation space 25 and connected with the lead-out conductive member 70. The number of the cell laminates 30 accommodated in the cell accommodation space 25 may be one or three or more.

A region of the front wall 82 that separates the cell accommodation space 25 from the output terminal accommodation space 27 (hereinafter, this portion is referred to as a partition wall 85) is lower in height than the other regions. The positive-side bus bar 62 and the negative-side bus bar 63 extend from above the partition wall 85 to the output terminal accommodation space 27, and are fixed to the terminal block 60 provided in the output terminal accommodation space 27.

As illustrated in FIG. 1, the output terminal accommodation space 27 is provided with a signal line connector 67. The signal line connector 67 is connected with a signal line via a through hole provided in the partition wall 85 to allow the cell accommodation space 25 to communicate with the output terminal accommodation space 27.

As illustrated in FIG. 2, the upper surface of the case 20 is attached with a case cover 23 via a first seal member 11 (for example, a rubber seal), except for the partition wall 85. The case cover 23 is fixed to the upper surface of the case 20 by welding such as friction stir welding, for example. The gap between the partition wall 85 and the case cover 23 is provided with a second seal member 12 (for example, a foamed seal). The cell accommodation space 25 is sealed from the outside by the first seal member 11 and the second seal member 12. By sealing the cell accommodation space 25 from the outside, it is possible to limit intrusion of foreign matters into the cell accommodation space 25, thereby limiting deterioration of the battery cells 40. It is preferable to further provide a seal member such as a foamed seal in the gap between the through hole provided in the partition wall 85 and the signal line.

The battery pack 10 configured as described above does not include an auxiliary device such as an ECU or a junction box that accommodates a comparator, a fuse, and the like. Therefore, if the battery pack 10 is used alone, the battery pack 10 may be connected to a junction box and/or an ECU. If a plurality of battery packs 10 are used, the battery packs 10 may be electrically connected to each other in a connection box, and the connection box may be connected to a junction box and/or an ECU. Further, a junction box and/or an ECU may be incorporated in a connection box, and the plurality of battery packs 10, the junction box and/or the ECU may be connected in the connection box.

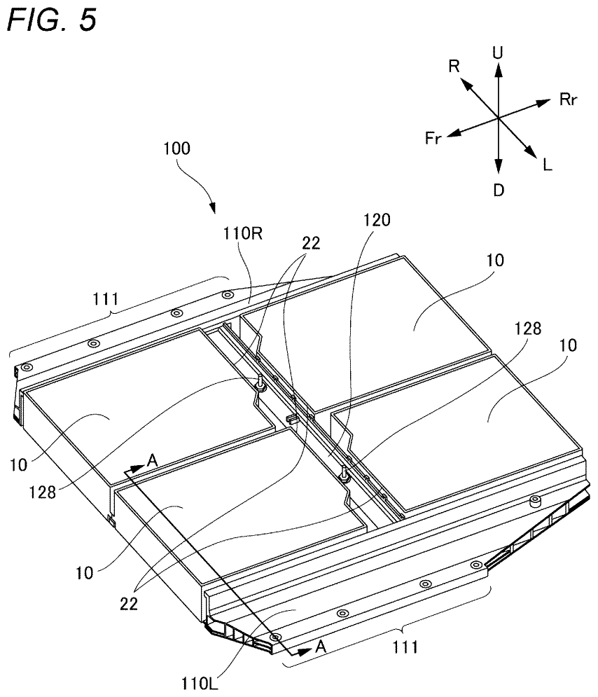

Next, an on-board structure for battery packs, in which four battery packs 10 are mounted under the floor of a vehicle, will be described with reference to FIGS. 5 to 9. In the following description, the front-rear direction, the left-right direction (vehicle width direction), and the upper-lower direction are defined with reference to the vehicle.

In this on-board structure, as illustrated in FIG. 5, a central frame 120 extending in the vehicle width direction is fixed between the left side frame 110L and the right side frame 110R extending in the front-rear direction of the vehicle. Two of the battery packs 10 are aligned in the left-right direction in a space forward of the central frame 120, and two of the battery packs 10 are aligned in the left-right direction in a space behind the central frame 120. Hereinafter, this structure will be referred to as a battery assembly 100.

### Battery Assembly

The two front battery packs 10 are arranged such that the expanded portion 22 is positioned on the rear and the right, and the two rear battery packs 10 are arranged such that the expanded portion 22 is positioned on the front and the left. That is, the two front battery packs 10 on the and the two rear battery packs 10 are arranged in a state of being rotated by 180° such that the expanded portions 22 face each other in the front-rear direction with the central frame 120 interposed therebetween.

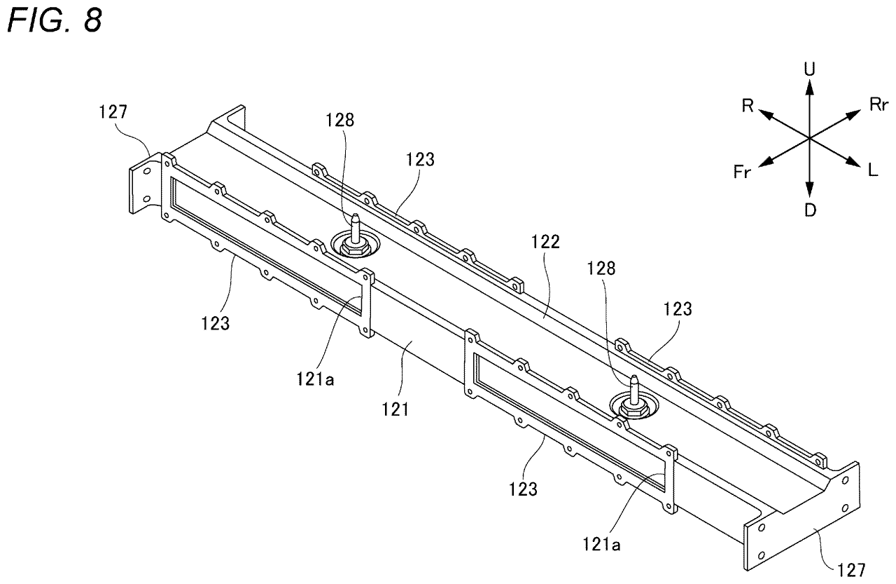

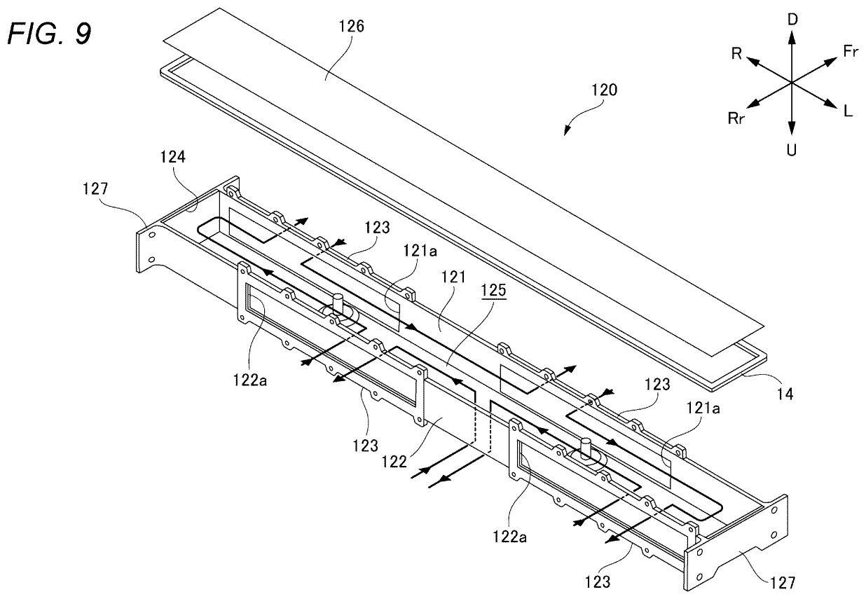

As illustrated in FIGS. 8 and 9, the central frame 120 of the battery assembly 100 is a hollow body having a rectangular cross section, and is fastened to the left side frame 110L and the right side frame 110R by flanges 127 formed at the left and right ends and extending in the front-rear direction.

A front surface 121 of the central frame 120 is formed with two front communication holes 121a, which respectively communicate with the first openings 91 formed in the expanded portions 22 of the front battery packs 10. Similarly, a rear surface 122 of the central frame 120 is formed with two rear communication holes 122a, which respectively communicate with the first openings 91 formed in the expanded portions 22 of the rear battery packs 10. The front communication hole 121a and the rear communication hole 122a are offset in the vehicle width direction. That is, the central position of the front communication hole 121a in the vehicle width direction and the central position of the rear communication hole 122a in the vehicle width direction are offset in the vehicle width direction.

Fastening portions 123 for fastening the corresponding battery packs 10 in a liquid-tight manner are provided around the front communication hole 121a and the rear communication hole 122a. Each battery pack 10 is fixed to the central frame 120 by, for example, bolt fastening. As illustrated in FIG. 8, the central frame 120 has the fastening portions 123 on the front surface 121 and the rear surface 122, respectively, and the front surface 121 and the rear surface 122 protrude vertically, thereby forming a high-rigidity cross-sectional shape like H steel in a cross section cut in the front-rear direction.

From the output terminal accommodation space 27 formed in the expanded portion 22 of each battery pack 10, the lead-out conductive member 70 enters a hollow region 125 of the central frame 120 through the first opening 91. As described above, since the first opening 91 of each battery pack is offset in the left-right direction relative to the central line L, if the expanded portions 22 are rotated by 180° while facing each other in the front-rear direction with the central frame 120 interposed therebetween, the first openings 91 of the front battery packs 10 and the first openings 91 of the rear battery pack 10 are offset in the vehicle width direction. Thus, the front communication holes 121a communicating with the first openings 91 of the front battery packs 10 and the rear communication holes 122a communicating with the first openings 91 of the rear battery packs 10 are offset in the vehicle width direction. Therefore, it is possible to secure a fastening space of the lead-out conductive member 70.

Similarly, since the terminal block 60 of each battery pack is offset in the left-right direction relative to the central line L, the terminal blocks 60 of the front battery packs 10 and the terminal blocks 60 of the rear battery packs 10 are offset in the left-right direction. Accordingly, the lead-out conductive members 70 connected to the bus bar unit 140 through the front communication holes 121a from the terminal blocks 60 of the front battery packs 10 and the lead-out conductive members 70 connected to the bus bar unit 140 through the rear communication holes 122a from the terminal blocks 60 of the rear battery packs 10 are offset in the vehicle width direction. The lead-out conductive members 70 extending from the front battery packs 10 and the lead-out conductive members 70 extending from the rear battery packs 10 do not interfere with each other in the hollow region 125 of the central frame 120.

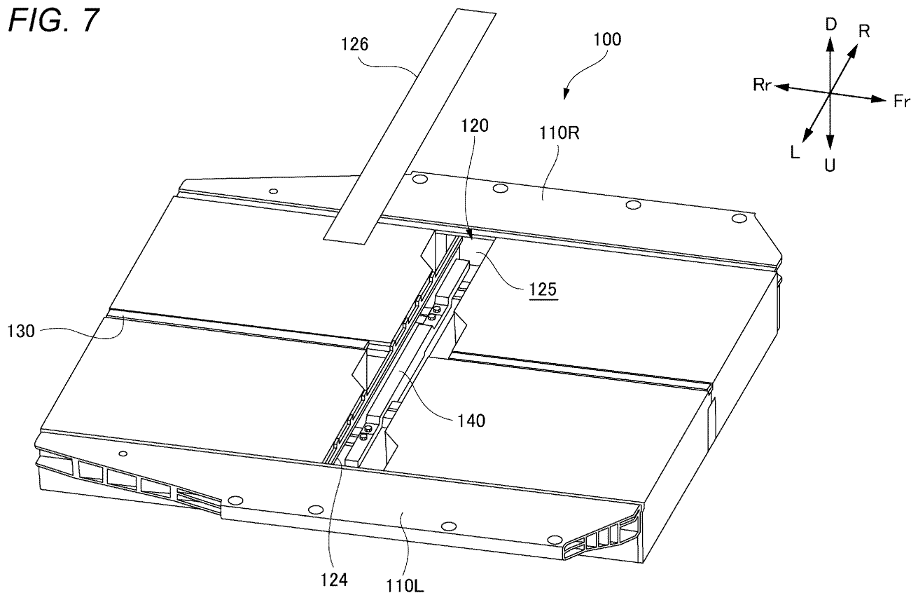

As illustrated in FIG. 7, the bus bar unit 140 is arranged in the hollow region 125 of the central frame 120. The bus bar unit 140 includes, for example, a plurality of connection bus bars, and electrically connects the four battery packs 10 in series as indicated by the arrows in FIG. 9. The central frame 120 is an example of the above-described connection box.

The back surface of the central frame 120 is provided with a bottom opening 124. The bottom opening 124 is closed in a liquid-tight manner by the bottom cover 126 via a sealing member 14 (see FIG. 9). The bottom opening 124 of the central frame 120 is closed by the bottom cover 126 in a liquid-tight manner, and the communication holes 121a and 122a of the central frame 120 and the first openings 91 of the battery packs 10 are fastened in a liquid-tight manner. This restricts the entry of water from the outside into the output terminal accommodation space 27 of the battery pack 10 and the internal space of the central frame 120. The lead-out conductive member 70 extending from each battery pack 10 to the hollow region 125 of the central frame 120 is fastened to the bus bar unit 140 from the bottom opening 124 with the bottom cover 126 detached.

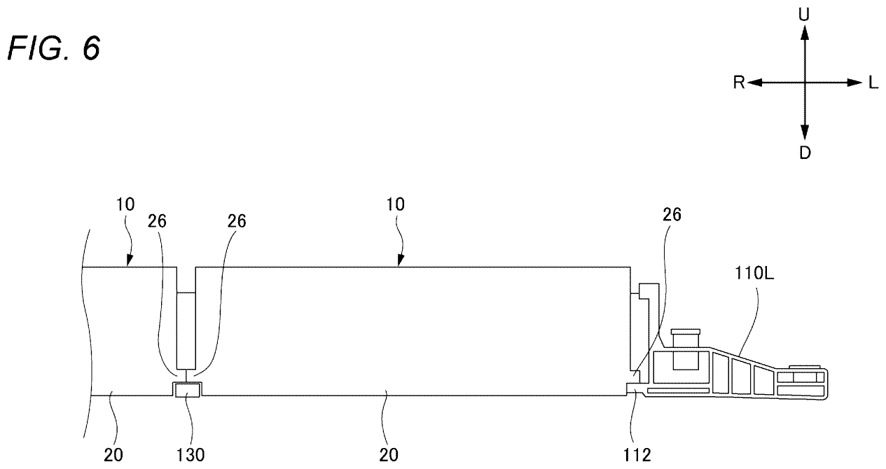

As illustrated in FIG. 6, the left side frame 110L has a pack holding portion 112 extending in the front-rear direction at an inner lower end portion, which holds the battery pack 10. More specifically, as described above, on the left and right side surfaces of the battery pack 10 (case 20), the protrusion 26 protruding in the direction away from the battery pack 10 extends in the front-rear direction below the intermediate portion in the height direction of the battery pack 10, and the bottom surface of the protrusion 26 is fixed to the pack holding portion 112 of the left side frame 110L. The same applies to the right side frame 110R, and the bottom surface of the protrusion 26 is fixed to the pack holding portion 112 of the right side frame 110R. Thus, the bottom surface of each battery pack 10 is fixed to the left side frame 110L or the right side frame 110R.

The protrusions 26 of the left battery pack 10 and the right battery pack 10 are in contact with each other, and the bottom surfaces of the protrusions 26 are fixed to a plate-shaped bracket 130 extending in the front-rear direction of the vehicle from below. Thus, the left and right battery packs 10 are fixed to each other.

As described above, in the left battery pack 10 and the right battery pack 10, the protrusions 26 provided below the intermediate portions in the height direction of the battery packs 10 come into contact with each other. Therefore, at the time of a side collision of the vehicle, the protrusions 26 are deformed in a manner protruding downward while being in contact with each other. This can limit deformation of the floor panel of the vehicle toward the passenger compartment.

If the height of the protrusion 26 is the same height as the bottom surface of the battery pack 10 or if the battery pack 10 is not provided with the protrusion 26, the bottom surface of the battery pack 10 is preferably fixed to the left side frame 110L or the right side frame 110R. Further, it is preferable that the side surfaces of the left battery pack 10 and the right battery pack 10 are in contact with each other, and the bottom surfaces thereof are fixed to the plate-shaped bracket 130 extending in the front-rear direction of the vehicle from below.

The battery assembly 100 configured as described above is fixed to the frame member of the vehicle by a pair of central supports 128 provided on the central frame 120 illustrated in FIG. 8 and protruding upward, and side supports 111 provided on the left side frame 110L and the right side frame 110R illustrated in FIG. 5, and is arranged under the floor of the vehicle. More specifically, the pair of central supports 128 provided in the central frame 120 is fixed below a floor frame extending in the vehicle width direction of the vehicle, and the side supports 111 provided on the left side frame 110L and the right side frame 110R are fixed below a pair of side frames extending in the front-rear direction of the vehicle.

As described above, the central frame 120 has the bus bar unit 140 for electrically connecting the four battery packs 10 arranged in the hollow region 125 thereof. In other words, in the battery assembly 100, the member for arranging the bus bar unit 140 for electrically connecting the battery packs 10 functions as the central frame 120, and the battery assembly 100 is fixed to the vehicle via the central frame 120 and the side frames 110L and 110R. This allows a plurality of highly versatile battery packs 10 to be mounted on the vehicle while reducing the number of components and saving space.

Although the various embodiments have been described above with reference to the drawings, it is needless to say that the present invention is not limited to these examples. It is apparent that those skilled in the art can conceive of various modifications and changes within the scope described in the claims, and it is understood that such modifications and changes naturally fall within the technical scope of the present invention. In addition, the constituent elements in the above embodiments may be freely combined without departing from the gist of the invention.

For example, in the above-described embodiment, the battery assembly 100 is constituted by four battery packs 10 in total on the front, rear, left, and right, but is not limited thereto. A configuration of two battery packs 10 in total, respectively on the front and the rear, is also possible. Two or more battery packs 10 may be arranged on the front and the rear and/or on the left and the right.

The battery packs 10 may be provided with a water jacket integrally with or separately from the bottom wall 88.

In the present specification, at least the following matters are described. In the parentheses, the corresponding constituent elements and the like in the above embodiment are shown, but the present invention is not limited thereto.
(1) An on-board structure for battery packs, including:
a first battery pack (battery pack 10) and a second battery pack (battery pack 10) each accommodating a cell laminate (cell laminate 30) having a plurality of laminated battery cells (battery cells 40), the first battery pack and the second battery pack being arranged adjacent each other in a front-rear direction of a vehicle;
a central frame (central frame 120) disposed between the first battery pack and the second battery pack and extending in a vehicle width direction; and
a side frame (left side frame 110L and right side frame 110R) disposed on at least one side in the vehicle width direction of the first battery pack and the second battery pack and extending in the front-rear direction,
in which the central frame has a hollow shape,
the central frame accommodates therein a conductive member (bus bar unit 140) that electrically connects the first battery pack and the second battery pack,
the first battery pack and the second battery pack are fixed to the central frame and the side frame, and
the central frame and the side frame are fixed to the vehicle.

According to (1), the member for arranging the conductive member electrically connecting the first battery pack and the second battery pack functions as the central frame member, and the plurality of highly versatile battery packs are fixed to the vehicle via the central frame member and the side frames. This allows a plurality of highly versatile battery packs to be mounted on the vehicle while reducing the number of components and saving space.
(2) The on-board structure for the battery packs according to (1), further including:
a third battery pack (battery pack 10) accommodating a cell laminate (cell laminate 30) having a plurality of laminated battery cells (battery cells 40), the third battery pack being arranged adjacent to the first battery pack in the vehicle width direction; and
a bracket (bracket 130) disposed between the first battery pack and the third battery pack and extending in the front-rear direction,
in which the first battery pack and the third battery pack have protrusions (protrusions 26) protruding toward each other on surfaces facing each other,
the protrusions are provided below intermediate portions in a height direction of the first battery pack and the third battery pack, and
bottom surfaces of the protrusions are fixed to the bracket.

According to (2), at the time of a side collision of the vehicle, the protrusions are deformed in a manner protruding downward while being in contact with each other, thereby limiting deformation of the floor panel toward the passenger compartment.
(3) The on-board structure for the battery packs according to (1) or (2),
in which the side frame is fixed to bottom surfaces of the first battery pack and the second battery pack.

According to (3), it is possible to prevent a load input during a side collision of the vehicle from being input to the battery cell.
(4) The on-board structure for the battery packs according to (2),
in which the side frame is fixed to the bottom surfaces of the protrusions of the first battery pack and the second battery pack.

According to (4), it is possible to prevent a load input during a side collision of the vehicle from being input to the battery cell.
(5) The on-board structure for the battery packs according to any one of (1) to (4),
in which the central frame and the first battery pack have first communication holes (first opening 91 and front communication hole 121a) that communicate with each other,
the central frame and the second battery pack have second communication holes (first opening 91 and rear communication hole 122a) that communicate with each other, and
the first communication holes and the second communication holes are offset in the vehicle width direction.

According to (5), it is possible to secure a fastening space for a lead-out conductive member extending from a terminal block of the first battery pack and connected to the conductive member and a lead-out conductive member extending from a terminal block of the second battery pack and connected to the conductive member.
(6) The on-board structure for the battery packs according to any one of (1) to (5),
in which the central frame has a bottom opening (bottom opening 124) in a bottom surface thereof, and
the bottom opening is sealed by a lid member (bottom cover 126) via a sealing member (sealing member 14).

According to (6), it is possible to perform connection work from the bottom opening, and to avoid water from entering the central frame.
(7) The on-board structure for the battery packs according to any one of (1) to (6),
in which the central frame and the first battery pack have first communication holes (first opening 91 and front communication hole 121a) that communicate with each other,
the central frame and the second battery pack have second communication holes (first opening 91 and rear communication hole 122a) that communicate with each other, and
a terminal block (terminal block 60) of the first battery pack and a terminal block (terminal block 60) of the second battery pack are offset in the vehicle width direction.

According to (7), it is possible to limit the interference between a lead-out conductive member extending from the terminal block of the first battery pack and connected to the conductive member and a lead-out conductive member extending from the terminal block of the second battery pack and connected to the conductive member.
(8) The on-board structure for the battery packs according to (7),
in which the first battery pack and the second battery pack have a same shape, and
the terminal blocks of the first battery pack and the second battery pack are offset in the vehicle width direction relative to a central line in the vehicle width direction of the first battery pack and the second battery pack.

According to (8), the positions of the terminal blocks can be offset by arranging battery packs having the same shape in a state of being rotated by 180° while facing each other in the front-rear direction.

What is claimed is:

1. An on-board structure for battery packs, comprising:
a first battery pack and a second battery pack each accommodating a cell laminate having a plurality of laminated battery cells, the first battery pack and the second battery pack being arranged adjacent each other in a front-rear direction of a vehicle;
a central frame disposed between the first battery pack and the second battery pack and extending in a vehicle width direction; and
a side frame disposed on at least one side in the vehicle width direction of the first battery pack and the second battery pack and extending in the front-rear direction,
wherein the central frame has a hollow shape,
the central frame accommodates therein a conductive member that electrically connects the first battery pack and the second battery pack,
the first battery pack and the second battery pack are fixed to the central frame and the side frame, and
the central frame and the side frame are fixed to the vehicle.

2. The on-board structure for the battery packs according to claim 1, further comprising:
a third battery pack accommodating a cell laminate having a plurality of laminated battery cells, the third battery pack being arranged adjacent to the first battery pack in the vehicle width direction; and
a bracket disposed between the first battery pack and the third battery pack and extending in the front-rear direction,
wherein the first battery pack and the third battery pack have protrusions protruding toward each other on surfaces facing each other,
the protrusions are provided below intermediate portions in a height direction of the first battery pack and the third battery pack, and
bottom surfaces of the protrusions are fixed to the bracket.

3. The on-board structure for the battery packs according to claim 1,
wherein the side frame is fixed to bottom surfaces of the first battery pack and the second battery pack.

4. The on-board structure for the battery packs according to claim 2,
wherein the side frame is fixed to the bottom surfaces of the protrusions of the first battery pack and the second battery pack.

5. The on-board structure for the battery packs according to claim 1,
wherein the central frame and the first battery pack have first communication holes that communicate with each other,
the central frame and the second battery pack have second communication holes that communicate with each other, and
the first communication holes and the second communication holes are offset in the vehicle width direction.

6. The on-board structure for the battery packs according to claim 5,
wherein the central frame has a bottom opening in a bottom surface thereof, and
the bottom opening is sealed by a lid member via a sealing member.

7. The on-board structure for the battery packs according to claim 1,
wherein the central frame and the first battery pack have first communication holes that communicate with each other,
the central frame and the second battery pack have second communication holes that communicate with each other, and
a terminal block of the first battery pack and a terminal block of the second battery pack are offset in the vehicle width direction.

8. The on-board structure for the battery packs according to claim 7,
wherein the first battery pack and the second battery pack have a same shape, and
the terminal blocks of the first battery pack and the second battery pack are offset in the vehicle width direction relative to a central line in the vehicle width direction of the first battery pack and the second battery pack.
